(19) United States
(12) Patent Application Publication
(10) Pub. No.: US 2006/0235684 A1
(43) Pub. Date: Oct. 19, 2006

(54) Wireless device to access network-based voice-activated services using distributed speech recognition

(75) Inventor: Hisao M. Chang, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP, Reno, NV (US)

(21) Appl. No.: 11/106,016

(22) Filed: Apr. 14, 2005

(51) Int. Cl. G10L 15/00

(52) U.S. Cl. 704/233

(57) ABSTRACT

A speech utterance is sensed using a mobile telecommunication device. The speech utterance is compressed into compressed data that is communicated from the mobile telecommunication device to a remote system. The remote system performs a first remote attempt to recognize the speech utterance using a personal directory specific to the mobile telecommunication device, and a second remote attempt to recognize the speech utterance using a group directory for a group of which the mobile telecommunication device is a member. At least one remote recognition result is communicated back to the mobile telecommunication device based on the first and second remote attempts. The mobile telecommunication device performs a local attempt to recognize the speech utterance and retrieves at least one local recognition result based thereon. A final recognition result set is determined based on the at least one local recognition result and the at least one remote recognition result.

### BACKGROUND

1. Field of the Disclosure

The present disclosure relates to methods and systems for distributed speech recognition.

2. Description of the Related Art

Mobile telephone service providers have offered voice-activated services (VAS) to their wireless users for years. An example of a VAS is voice-activated dialing (VAD). VAD services are enabled by either a local device-based VAD module (i.e. one that is built into a wireless device) or a remote network-based VAD system.

The functionality and performance of device-based VAD is limited by cost, size and battery-power factors associated with cellular telephones and personal digital assistants (PDAs). For example, current cellular telephones with built-in VAD may support a voice directory of up to 75 short names such as “John Smith's Office”.

Network-based VAD provides more computing power available to perform speech recognition and to support a larger voice directory. The network-based VAD is accessible by dialing a special access code (e.g. “#8”). However, because the users talk to the network-based VAD over a wireless network, the quality of voice transmission is subject to degradation due to radio interference and/or territorial factors. These factors negatively affect the speech recognition accuracy of the VAD. In addition, the network-based VAD is normally designed to assume that all incoming wireless connections have the same channel characteristics, and all users speak in a similar acoustic environment. All these factors limit the speech recognition performance of the network-based VAD even with the more extensive VAD infrastructure on the network side.

### BRIEF DESCRIPTION OF THE DRAWINGS

FIG. 1 is a schematic block diagram of an embodiment of a distributed network-based VAS system;

FIG. 2 is a schematic block diagram of another embodiment of the distributed network-based VAS system; and

FIG. 3 is a flow chart of acts performed in an embodiment of the distributed network-based VAS system of FIG. 2.

### DETAILED DESCRIPTION OF THE DRAWINGS

Embodiments of the present invention provide an improved speech recognition method and system for use in residential and enterprise voice-activated services. A speech input to a client device (e.g. a cellular telephone or a PDA) is split into two high-bandwidth audio streams. One stream is directed to a personal speech recognition system on the device, and another stream is directed to a compressor that transforms high-bandwidth speech into a low-bandwidth feature set. The low-bandwidth feature set is sent over a wireless over-the-air channel to a service-wide speech recognition system.

The personal speech recognition system on the device uses multiple local acoustic models that are automatically adapted to the device, acoustic environments and times of days, to attempt to recognize the speech input. The service-wide speech recognition system performs multiple speech recognition tasks using multiple voice search engines. The tasks may be performed simultaneously.

A first search engine uses a service-specific common directory as its search space. This common directory may be a nationwide 411 directory. Word models used to construct this common voice search space are automatically adjusted based on usage patterns from all users. For example, if Los Angeles is the most frequently requested city from which a user tries to find a person named “Howard Lee”, the corresponding word models for Los Angeles will have a higher ranking to be selected for a potential match.

A second search engine uses a community directory as its search space. This search space ranks word models according to usage patterns from a smaller user community. For example, if the user is classified as a “Los Angeles” user (e.g. one whose use of the service is more than 50% of the time in Los Angeles during the last W weeks), the second search engine will have a higher success rate to match the user input “Howard Lee” to the correct entry. The higher success rate is because the last name “Lee” may be ranked in the top 30 for the Los Angeles directory but be ranked well below the top 30 on a nationwide 411 directory.

A third search engine tries to match the speech input to a user-specific personalized directory created by the user. The user-specific personalized directory may be created via a Web interface, and may include all recognized names previously used by the user. The third search engine is beneficial in recognizing speech input intended for a name on this personal directory, including those names that are rarely called (e.g. once in five years).

The client device determines a final recognition result based on at least one local recognition result generated at the client device, at least one remote recognition result from the remote search engines, and other session-specific information.

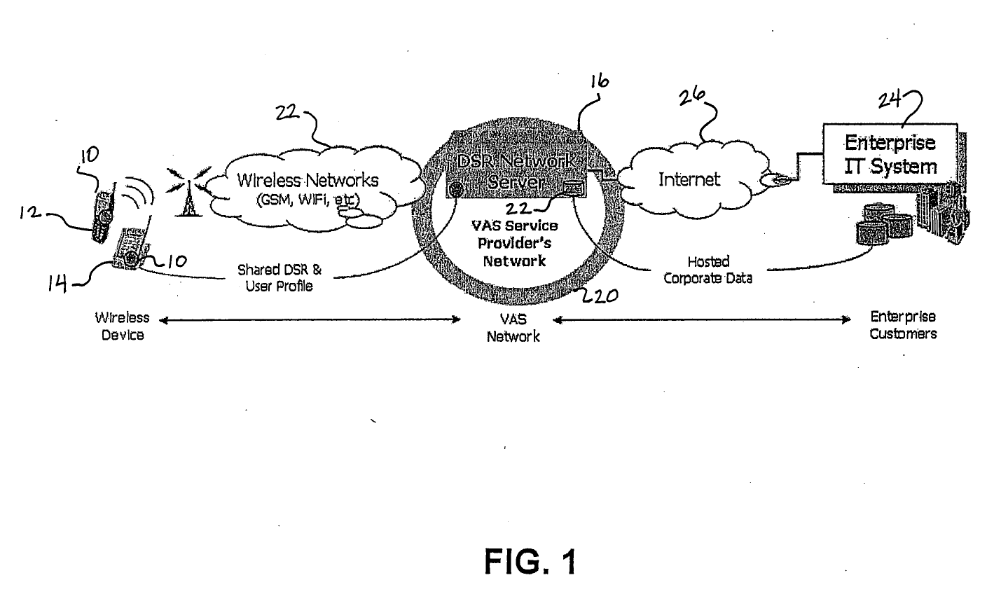

FIG. 1 is a schematic block diagram of an embodiment of a distributed network-based VAS system. The VAS system provides voice-activated services to mobile telecommunication devices 10 such as a mobile telephone 12 (e.g. a cellular telephone) and a PDA 14 having a wireless interface.

A distributed speech recognition (DSR) subsystem comprising a DSR network server 16 cooperates with the mobile telecommunication devices 10 to provide the voice-activated services. The DSR network server 16 is part of a network 20 of a provider of the voice-activated services. The mobile telecommunication devices 10 communicate with the DSR network server 16 via one or more wireless networks 22. Examples of the one or more wireless networks 22 include, but are not limited to, a cellular wireless telephone network (e.g. a GSM network or a CDMA network), a wireless computer network (e.g. WiFi or 802.11x), and a satellite network.

The mobile telecommunication devices 10 are operative to locally attempt to recognize speech utterances using an adaptive acoustic model, and to communicate compressed versions of speech utterances to the DSR network server 16 via the wireless network(s) 22. The DSR network server 16 is operative to attempt to recognize the compressed speech utterances using multiple search engines selected based on an identifier of a mobile telecommunication device, and to communicate at least one remote recognition result back to the mobile telecommunication device. The multiple search engines may comprise a first search based on a personalized ASR grammar corresponding to the identifier, a second search based on a directory for a group of which the device is a member, and a third search based on a service-wide directory. The network-based VAS system can host a personal VAD directory, which is an example of the personalized ASR grammar, a corporate voice directory 22, which is an example of the directory for a group of devices, and a nationwide 411 directory which is an example of the service-wide directory. The mobile telecommunication devices 10 determine a final recognition result based on at least one local recognition result, at least one remote recognition result, a time-of-day and a device location.

The corporate voice directory 22 can be synchronized with data from an enterprise information technology (IT) system 24 over a computer network such as the Internet 26. As a result, enterprise customers can access both their personal VAD directory and a company directory by speech.

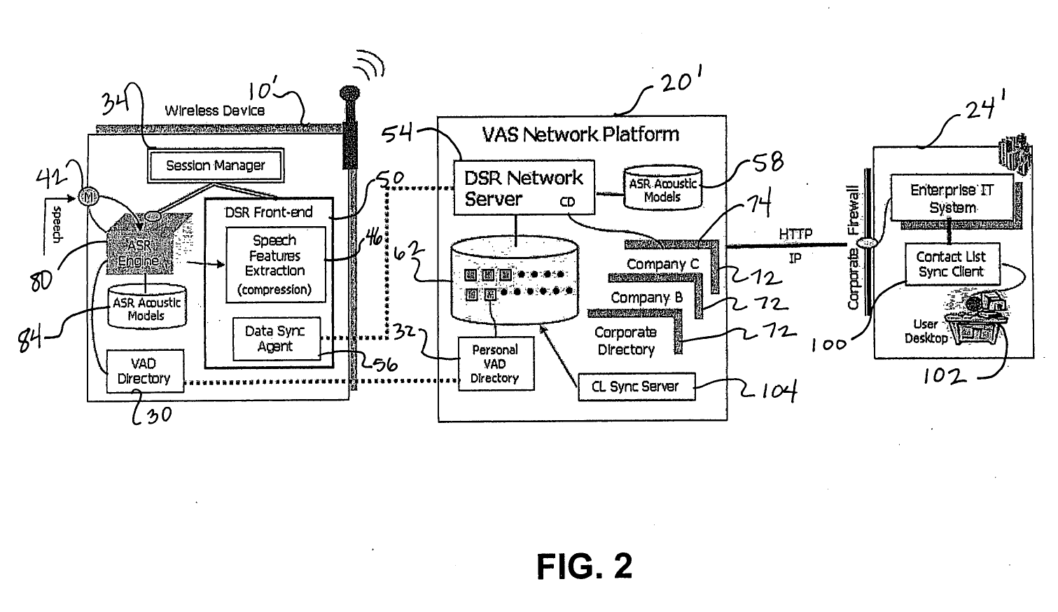

FIG. 2 is a schematic block diagram of another embodiment of the distributed network-based VAS system. Unlike existing device-based VAD systems, the intelligence to enable VAS is shared by a wireless telecommunication device 10′ and the VAS network platform 20′.

The wireless telecommunication device 10′ comprises a local VAD directory 30. The local VAD directory 30 stores entries that are either explicitly downloaded from a personal VAD directory 32 specific to the wireless device 10′ in the VAS network platform 20′ or implicitly added from call logs of the wireless telecommunication device 10′. The local VAD directory 30 is stored as a subset of the subscriber's personal VAD directory 32 on the VAS network platform 20′. The local VAD directory 30 is dynamically maintained to achieve a desirable level of performance for frequently requested entries.

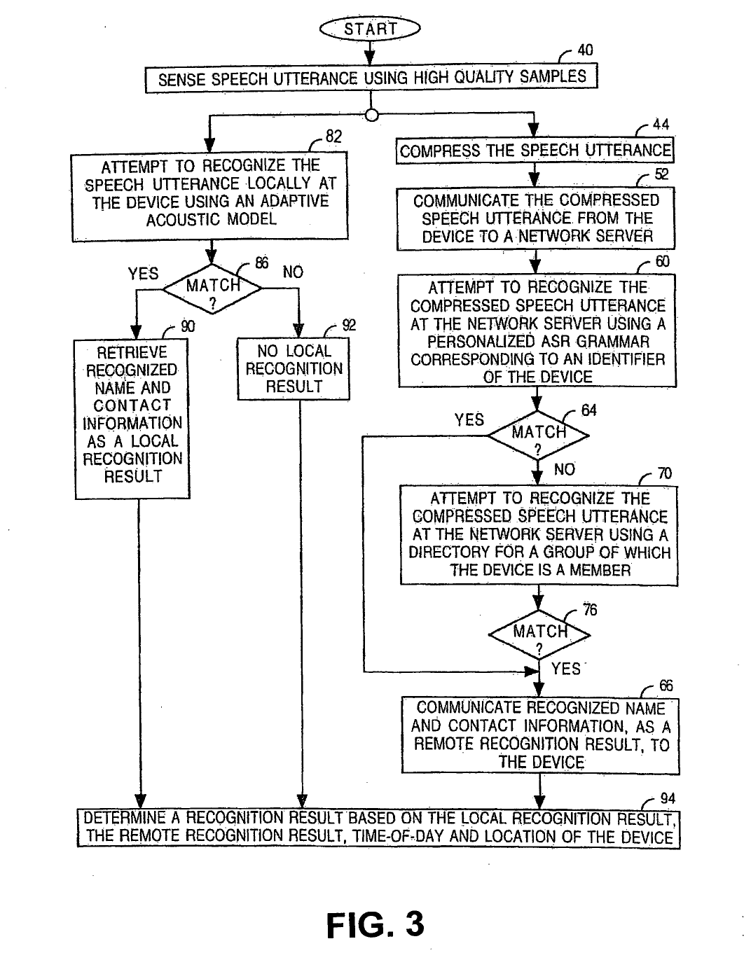

A session manager 34 coordinates acts performed locally at the wireless telecommunication device 10′ with acts performed remotely at the VAS network platform 20′. FIG. 3 is a flow chart of the acts performed in an embodiment of the distributed network-based VAS system of FIG. 2.

As indicated by block 40, an audio input device 42 of the wireless telecommunication device 10′ senses and records a speech utterance made by a user. The audio input device 42 includes a microphone and a digital sampler. The digital sampler may provide a high quality representation of the speech utterance, e.g. one that is digitized at 16000 or more samples per second with 16 or more bits per sample.

As indicated by block 44, the digitized speech utterance is compressed by a speech features extraction module 46 responsive to the audio input device 42. The speech features extraction module 46 is part of a DSR front end 50 included in the wireless telecommunication device 10′. The speech features extraction module 46 applies a set of mathematical transformations to the original digitized speech utterance to compute a set of speech features. Examples of the speech features include, but are not limited to, cepstrum coefficients, pitch and loudness. The features are re-computed for different time segments of the original digitized speech.

In one embodiment, the speech features are computed for every 20 milliseconds of digitized speech. Each speech feature set may be represented by twenty floating point numbers of 40 bytes, for example. In this case, the DSR front end 50 is able to compress each second of source speech (at 256 kbps) to 50 packets of speech data at 40 bytes per packet. The resultant data set, although highly compressed, contains substantially all information in the original digitized speech signal that is needed for speech recognition.

As indicated by block 52, the compressed speech utterance (comprising the speech features set) is communicated from the wireless telecommunication device 10′ to a DSR network server 54. A data sync agent 56 of the DSR front end 50 is responsible for communicating the compressed speech utterance to the DSR network server 54. The compressed speech utterance may be communicated over a high-speed wireless data link such as a 3G mobile data service or a WiFi hot spot.

The compressed speech utterance is communicated within packetized data frames sent via the wireless data link. A zero-loss transmission can be achieved using frame redundancy techniques and checksum algorithms for detecting recoverable packet loss.

The data sync agent 56 does not wait until the user finishes speaking (which may take two or three seconds) before sending a speech features set. In the above embodiment, the data sync agent 56 sends to the DSR network server 54 a new feature set just computed for the last speech frame every 20 milliseconds. As each feature set is received, the DSR network server 54 attempts to recognize the corresponding segment of the speech as subsequently described. This reduces delay between the end of the user's speech input and the DSR network server 54 having a complete recognition result. Each attempt to recognize the speech utterance can use one more automatic speech recognition models 58.

As indicated by block 60, the DSR network server 54 performs a first attempt to recognize the speech utterance using a personalized directory (which comprises a personalized ASR grammar) corresponding to an identifier of the wireless telecommunication device 10′. In one embodiment, the identifier is the mobile identification number (MIN) of the wireless telecommunication device 10′. For the wireless telecommunication device 10′, the personalized directory is the personal VAD directory 32. The VAS network platform 20′ has a database 62 that stores a plurality of different personalized directories for a plurality of different wireless telecommunication devices 10.

As indicated by block 64, the DSR network server 54 determines whether or not the first attempt has resulted in a successful match, with high confidence, between the compressed speech utterance and an entry (e.g. “John Smith” or “XYZ Drug Store at 620”) in the personalized directory. If the DSR network server 54 is successful in the first attempt, the DSR network server 54 communicates a recognized name and contact information as a remote recognition result to the wireless telecommunication device 10′ (as indicated by block 66). The contact information may comprise a telephone number or an e-mail address for a person or a place associated with the recognized name.

Referring back to block 64, if the DSR network server 54 is unsuccessful in the first attempt, the DSR network server 54 performs a second attempt to recognize the speech utterance using a group directory for a group of which the wireless telecommunication device 10′ or its user is a member (as indicated by block 70). Examples of the group include an enterprise and a corporation. The group is predefined from a previous registration event for the wireless telecommunication device 10′. When a wireless telecommunication device is being registered, the MIN of the device is tagged with a group identification code. For example, when an enterprise end user registers his/her wireless telecommunication device, the MIN of the device is tagged with a unique enterprise client ID such as a company code. The VAS network platform 20′ supports multiple groups (e.g. multiple enterprise customers) by maintaining separate group directories 72 (e.g. multiple corporate directories).

Consider the MIN of the wireless telecommunication device 10′ being a member of a group for an enterprise community (e.g. a large bank) having a particular enterprise client ID. The second attempt involves searching a group directory 74 including a corporate voice directory for the enterprise community identified by the particular enterprise client ID. Thus, if the first attempt is unsuccessful, the search is automatically expanded from a personal VAD directory to a pre-authorized corporate directory.

As indicated by block 76, the DSR network server 54 determines whether or not the second attempt has resulted in a successful match, with high confidence, between the compressed speech utterance and an entry in the group directory (e.g. “Mary Johnson at Corporate Marketing” or “Austin Network Operation Center”). If the DSR network server 54 is successful in the second attempt, the DSR network server 54 communicates a recognized name and contact information as a remote recognition result to the wireless telecommunication device 10′ (as indicated by block 66).

If the DSR network server 54 is unsuccessful in the first and second remote attempts, the DSR network server 54 may further perform a third remote attempt to recognize the speech utterance using a service-wide directory, and communicate any remote recognition result based thereon to the wireless telecommunication device 10′. Otherwise, no remote recognition result is communicated to the wireless telecommunication device 10′.

Optionally, multiple remote recognition results are communicated to the wireless telecommunication device 10′ in block 66. The recognition results from multiple search engines can be sorted based on their distance to the location of the wireless telecommunication device 10′. For example, each matching entry (e.g. each phone number) can be classified as being either in the same WiFi hot spot (about a 100-meter radius), in the same GSM radio transmission tower (about a 3-mile radius), in the same mobile switching area (about a 20-mile radius), in the same area code, in the same metropolitan area (e.g. Los Angeles metropolitan area), or in the same state (e.g. California). Based on the time of day and distance models generated from a user community, the top N matching candidates can be sent to the wireless telecommunication device 10′.

Concurrent with the aforementioned remote recognition acts are local recognition acts performed by an automatic speech recognition (ASR) engine 80 of the wireless telecommunication device 10′. As indicated by block 82, the ASR engine 80 performs a local attempt to recognize the speech utterance. The local attempt is based on the high quality samples from the audio input device 42, and is performed locally by the wireless telecommunication device 10′ using the VAD directory 30. The ASR engine 80 uses a local recognition grammar optimized for speech recognition performance, and contains most frequently requested names for VAD (e.g. “George's cell phone”) and/or commonly-used voice commands (e.g. “Weather in Austin, Tex.”).

The ASR engine 80 uses adaptive acoustic model(s) 84 stored by the wireless telecommunication device 10′. The adaptive acoustic models 84 are initially downloaded from the VAS network platform 20′. The adaptive acoustic models 84 are automatically updated according to one or more decision criteria. For example, the session manager 34 may automatically update the adaptive acoustic models 84 in an incremental manner based on each successful recognition event.

The adaptive acoustic models 84 are based on speech samples collected over a variety of acoustic environments that reflect typical usage patterns by mobile users. Examples of the acoustic environments include, but are not limited to, in-vehicle, walking and driving at various speeds. Over time, the adaptive acoustic models 84 will adapt to the acoustic environments from where the user most frequently uses the service.

Further, the adaptive acoustic models 84 are automatically adapted based on times of day. For example, the models 84 may include one or more morning models and one or more afternoon models because people have different speech dynamics at different times of day. In a more specific example, the models may comprise a morning commute model for 7:00 AM to 8:00 AM, an in-office model for 8:00 AM to 5:00 PM, and an evening commute model for 5:00 PM to 8:00 PM.

The adaptive acoustic models 84 are augmented with speaker-dependent word models that are expandable based on a storage capacity of the wireless telecommunication device 10′. The word models are dynamically maintained based on the frequency of the words used in different network environments and different times. For example, if a user accesses the service while the device is connected to a GSM network during a normal commute time, word models that are associated with typical speech input patterns recorded in the past during a similar time profile can be used.

In contrast, existing ASR engines built for telephony environments use the same set of acoustic models for both landline and wireless calls. By using both high quality speech samples as input and the adaptive acoustic models 84 built specifically for handling user utterances spoken into a wireless device such as a cellular telephone, the ASR engine 80 can achieve a better recognition result even with its limited computing capability.

As indicated by block 86, the ASR engine 80 determines whether or not the local attempt has resulted in a successful match, with high confidence, between the compressed speech utterance and an entry in the VAD directory 30. If the ASR engine 80 is successful in the local attempt, a recognized name and contact information are retrieved as a local recognition result (as indicated by block 90). Optionally, the ASR engine 80 retrieves multiple local recognition results in block 90. For example, the top M matching candidates can be retrieved as local recognition results. If the ASR engine 80 is unsuccessful in the local attempt, no local recognition result is retrieved (as indicated by block 92).

It is noted that the words “first”, “second” and “third” are used to label the various recognition attempts without necessarily implying their order of being performed. For example, any two or more of the first, second and third remote attempts may be performed concurrently. Further, the local attempt may be performed either before, or concurrently, or after any of the remote attempts.

As indicated by block 94, the session manager 34 determines a final recognition result based on the local recognition result(s) and the remote recognition result(s). If the same top match is found both locally by the ASR engine 80 and remotely by the DSR network server 54, the final recognition result is the same as the top local and remote recognition results.

If different matches are found by the ASR engine 80 and the DSR network server 54, the session manager 34 makes a decision on which recognition result to use based on additional session-specific information. Examples of the additional session-specific information include, but are not limited to, a time-of-day and a location of the wireless telecommunication device 10′. The location may be determined by a global positioning system (GPS) position sensor integrated with the wireless telecommunication device 10′.

For multiple remote and local recognition results, the top N matching candidates from the DSR network server 54 are compared to the top M matching candidates generated by the ASR engine 80. Those entries on both lists are selected as the final X entries. If X=1, the one entry on both lists is the final recognition result, and a proper post-recognition feature is executed based on the context of the search (e.g. a telephone number is automatically dialed based on the final recognition result, a command is automatically issued based on the final recognition result, or another VAS is automatically performed based on the final recognition result). If X>1, the decision logic will present the top X entries to the user (e.g. using a display screen of the wireless telecommunication device 10′ or audibly playing back the entries). The user can select one or more of the top X entries to cause a post-recognition feature to be performed (e.g. automatically dialing a telephone number of the user-selected entry, automatically performing a command indicated by the user-selected entry, or performing another VAS).

In general, the wireless telecommunication device 10′ performs a feature of a voice-activated service based on at least one entry of the final recognition result set. The feature may comprise automatically dialing or otherwise placing a call to at least one telephone number based on the at least one entry of the final recognition result set, or issuing at least one command associated with the at least one entry of the final recognition result set.

For multiple entries in the final recognition result set, the feature may comprise automatically dialing or otherwise placing calls to multiple telephone numbers based on the multiple entries. The feature may further comprise automatically sending a pre-recorded audible message in each of the calls to the multiple telephone numbers. The audible message may be pre-recorded by the user speaking into the wireless telecommunication device 10′, or may be another pre-recorded message.

The multiple telephone numbers may be dialed either in a broadcast mode, a sequential dial mode, or a dial-first-connect mode. In the broadcast mode, the multiple telephone numbers are dialed substantially simultaneously. In the sequential dial mode, all of the multiple telephone numbers associated with the entries are dialed one-by-one in sequence. In the dial-first-connect mode, one or more of the multiple telephone numbers are dialed one-by-one in sequence until an associated telephone call is answered (at which time no further ones of the multiple telephone numbers are dialed).

Alternatively, for multiple entries in the final recognition result set, the feature may comprise issuing multiple commands based on the multiple entries. An example of a command is to send an urgent text message to multiple wireless devices (e.g. mobile telephones with data display capability) based on the multiple entries.

Use of the local ASR engine 80, the remote DSR network server 54 and the session-specific information improves the recognition performance even when the size of the VAD directory contains a large number (e.g. over a thousand) entries. By using multiple search engines, enterprise users can voice dial a corporate contact just as they can access their personal VAD directory by voice without switching a mode.

The voice-activated service provider may offer contact list sync client software 100 to its enterprise IT customers and to other customers. The software 100 provides a tool for a computer 102, such as a desktop computer, to sync its contact list (e.g. one generated using MICROSOFT® OUTLOOK) with a contact list in the VAS network platform 20′. Executing the software 100 causes the contact list to be uploaded to a personal directory stored by the database 62. A contact list sync server 104 cooperates with the software 100 to construct an appropriate personal VAD directory in the database 62 for a registered VAS user.

Further, an enterprise can upload its corporate directory from the enterprise IT system 24′ to the VAS network platform 20′. Optionally, the enterprise can restrict access to specific portion(s) of the corporate directory by specific users.

Optionally, the DSR network server 54 automatically modifies the group directory 74 based on how individual members of the group modify their personal directories. For example, the DSR network server 54 can automatically add an entry to the group directory 74 in response to detecting that a number of the individual members of the group have added the same entry to their personal directories. For instance, if the number that have added the same entry in the last D days attains or exceeds a threshold value, the DSR network server 54 automatically adds the entry to the group directory 74. This frequency-based promotion method acts to anticipate a request for the same entry by other users in the group, and thereby improve the speech recognition performance.

The herein-described components of the wireless telecommunication device 10′ may be embodied by one or more computer processors directed by computer-readable program code stored by a computer-readable medium. The herein-described components of the VAS network platform 20′ may be embodied by one or more computer processors directed by computer-readable program code stored by a computer-readable medium.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
sensing a speech utterance using a mobile telecommunication device;
compressing the speech utterance by the mobile telecommunication device to generate compressed data;
communicating the compressed data from the mobile telecommunication device to a remote system;
performing a first remote attempt to recognize the speech utterance by the remote system based on the compressed data using a personal directory specific to the mobile telecommunication device;
performing a second remote attempt to recognize the speech utterance by the remote system based on the compressed data using a group directory for a group of which the mobile telecommunication device is a member;
communicating at least one remote recognition result from the remote system to the mobile telecommunication device based on the first remote attempt and the second remote attempt;
performing a local attempt to recognize the speech utterance locally by the mobile telecommunication device;
retrieving at least one local recognition result based on the local attempt; and
determining a final recognition result set based on the at least one local recognition result and the at least one remote recognition result.

2. The method of claim 1 wherein said determining the final recognition set is further based on a location of the mobile telecommunication device.

3. The method of claim 1 wherein said performing the local attempt to recognize the speech utterance is based on a plurality of acoustic models for a plurality of different times of day.

4. The method of claim 1 further comprising:
performing a third remote attempt to recognize the speech utterance by the remote system based on the compressed data using a service-wide directory;
wherein the at least one remote recognition result is further based on the third remote attempt.

5. The method of claim 1 further comprising:
selecting which results of the first remote attempt and the second remote attempt to include in the at least one remote recognition result based on their distance to a location of the mobile telecommunication device.

6. The method of claim 1 wherein each entry in the final recognition result set is a member of both the at least one local recognition result and the at least one remote recognition result.

7. The method of claim 1 further comprising:
performing a feature of a voice-activated service based on at least one entry of the final recognition result set.

8. The method of claim 7 wherein the feature comprises automatically dialing at least one telephone number based on the at least one entry of the final recognition result set.

9. The method of claim 7 wherein the at least one entry comprises a plurality of entries, and wherein the feature comprises automatically placing calls to a plurality of telephone numbers based on the plurality of entries of the final recognition result set.

10. The method of claim 9 wherein the feature further comprises sending a pre-recorded message in the calls to the plurality of telephone numbers.

11. The method of claim 7 wherein the feature comprises automatically issuing at least one command associated with the at least one entry of the final recognition result set.

12. The method of claim 11 wherein the command is to send a text message to a plurality of wireless devices based on the at least one entry of the final recognition result set.

13. The method of claim 1 wherein the local attempt is performed concurrently with at least one of the first remote attempt and the second remote attempt.

14. The method of claim 1 further comprising:
automatically adding an entry to the group directory in response to detecting that a number of members of the group have added the same entry to their personal directories.

15. A wireless telecommunication device comprising:
an audio input device to sense a speech utterance;
an automatic speech recognition engine responsive to the audio input device to perform a local attempt to recognize the speech utterance and to retrieve at least one local recognition result based on the local attempt;
a speech features extraction module responsive to the audio input device to compress the speech utterance into compressed data;
a data sync agent to communicate the compressed data to a remote system and to receive at least one remote recognition result from the remote system, the at least one remote recognition result based on a first remote attempt to recognize the speech utterance by the remote system based on the compressed data using a personal directory specific to the mobile telecommunication device, the at least one remote recognition result further based on a second remote attempt to recognize the speech utterance by the remote system based on the compressed data using a group directory for a group of which the mobile telecommunication device is a member; and
a session manager to determine a final recognition result set based on the at least one local recognition result and the at least one remote recognition result.

16. The wireless telecommunication device of claim 15 wherein the session manager is to determine the final recognition set based on a location of the mobile telecommunication device.

17. The wireless telecommunication device of claim 15 wherein the automatic speech recognition engine performs the local attempt to recognize the speech utterance based on a plurality of acoustic models for a plurality of different times of day.

18. The wireless telecommunication device of claim 15 wherein the at least one remote recognition result is further based on a third remote attempt to recognize the speech utterance by the remote system based on the compressed data using a service-wide directory.

19. The wireless telecommunication device of claim 15 wherein each entry in the final recognition result set is a member of both the at least one remote recognition result and the at least one remote recognition result.

20. The wireless telecommunication device of claim 15 wherein the session manager initiates performing a feature of a voice-activated service based on at least one entry of the final recognition result set.

21. The wireless telecommunication device of claim 20 wherein the feature comprises automatically dialing at least one telephone number based on the at least one entry of the final recognition result set.

22. The wireless telecommunication device of claim 20 wherein the at least one entry comprises a plurality of entries, and wherein the feature comprises automatically placing calls to a plurality of telephone numbers based on the plurality of entries of the final recognition result set.

23. The wireless telecommunication device of claim 22 wherein the feature further comprises sending a pre-recorded message in the calls to the plurality of telephone numbers.

24. The wireless telecommunication device of claim 20 wherein the feature comprises automatically issuing at least one command associated with the at least one entry of the final recognition result set.

25. The wireless telecommunication device of claim 24 wherein the command is to send a text message to a plurality of wireless devices based on the at least one entry of the final recognition result set.

26. The wireless telecommunication device of claim 15 wherein the local attempt is performed concurrently with at least one of the first remote attempt and the second remote attempt.

27. The wireless telecommunication device of claim 15 wherein the automatic speech recognition engine performs the local attempt to recognize the speech utterance based on a plurality of adaptive acoustic models.
